(19) United States
(12) Patent Application Publication
(10) Pub. No.: US 2024/0336496 A1
(43) Pub. Date: Oct. 10, 2024

(54) SORBENTS AND METHODS FOR THE CAPTURE AND DEFLUORINATION OF PER AND POLY FLUOROALKYL SUBSTANCES (PFAS)

(71) Applicant: CLAROS TECHNOLOGIES INC., St. Paul, MN (US)

(72) Inventors: Abdennour ABBAS, Falcon Heights, MN (US); John Wilfrid BROCKGREITENS, Minneapolis, MN (US); Zijie XIA, Edina, MN (US); Evan LESLIE, Minneapolis, MN (US)

(73) Assignee: Claros Technologies Inc., Minneapolis, MN (US)

(21) Appl. No.: 18/555,135

(22) PCT Filed: Apr. 12, 2022
(86) PCT No.: PCT/US2022/024385

§ 371 Date: Oct. 12, 2023

Related U.S. Application Data
(60) Provisional application No. 63/173,785, filed on Apr. 12, 2021.

(51) Int. Cl. C02F 1/28; B01J 20/26; B01J 20/28; B01J 20/32; B01J 20/34; C02F 1/32; C02F 1/36; C02F 1/72; C02F 101/36

(52) U.S. Cl. CPC C02F 1/285; B01J 20/262; B01J 20/28007; B01J 20/28038; B01J 20/28045; B01J 20/3212; B01J 20/3214; B01J 20/3257; B01J 20/3293; B01J 20/3295; B01J 20/3425; C02F 1/288; C02F 1/32; C02F 1/36; C02F 1/722; C02F 2101/36; C02F 2303/16; C02F 2305/08

(57) ABSTRACT

Methods, systems and apparatuses for the capture, desorption and/or destruction of pollutants such as PFAS. The systems include porous polymer materials such as foams like polyurethane and may include nanoparticles and/or active chemical groups. The porous polymer may be activated to improve capture. Captured pollutants may be desorbed using solvents and mechanical methods, and the pollutants may then be concentrated and destroyed through the application of energy such as through acoustic energy, ultrasound, and/or light such as UV or visible light.

### BACKGROUND

Environmental pollution may be caused by industrial processes, fossil fuels, waste disposal, plastics, and other processes and materials. Many pollutants have the potential to cause significant harm to people, but once they are free in the environment, they are extremely difficult to remove. Pollution of waterways is of particular concern since we rely on clean drinking water to survive, and even very low levels of contamination may be damaging. People are increasingly aware of the need to prevent the release of pollutants into the environment. However, the environment is already contaminated by pollutants released in the past, and harmful pollutants continue to be released or to escape into the environment. As such, there is a great need to effectively and efficiently remove pollutants from the environment and to manage the pollutants after they are removed.

One class of chemical pollutants of concern is perfluoroalkyl and polyfluoroalkyl substances (PFAS). PFAS are a broad category of synthetic organofluorine compounds where all (per-) or some (poly-) of the hydrogen atoms in the alkyl chain are replaced by fluorine. These C—F groups enable PFAS to have remarkable chemical stability and hydrophobic properties, making them ideal for commercial use in waterproof coatings, firefighting foams and in chemical manufacturing. Fluorinated alkyl chains are commonly produced with hydrophilic end groups to enable water solubility and enhanced commercial applications. However, these compounds have been shown to be highly mobile and bioaccumulative in aquatic and marine environments. These compounds are so persistent that they have been found in Artic wildlife and in human tissues. While the potential toxic impacts of PFAS are still being researched, the prevalence of these chemicals has raised concern from public health and environmental protection agencies. Due to emerging regulatory pressures for PFAS in water sources, many industries and public utilities are seeking to update their treatment facilities. Because of the high cost of maintaining and upgrading these facilities, the unstable performance of current processes and the cost of disposal of their hazardous waste, industries are now seeking new technologies that can efficiently remove PFAS while reducing the capital investment and operational costs.

Various methods are known for capturing pollutants such as PFAS. However, such methods may be non-selective, may have low loading capacities, and there may be a risk of re-emission or leaching. In addition, the captured pollutants must still be managed to avoid recontamination of the environment and may need to be treated like toxic or hazardous waste. For example, they may be securely contained, transported and stored in a disposal facility such as a sealed underground vault. Even if the captured pollutant can be removed from the sorbent, the result of this process is a concentrated waste product of released pollutants, typically a liquid, which must then be further managed. For example, the pollutants in the waste product may be treated with a degradation process. However, the products of this degradation may themselves be harmful to the environment. Another disposal method includes incineration in which the pollutant bound sorbent material is burned, such as in an industrial furnace, to destroy the contaminants and the sorbent material. However, incineration can release unwanted material into the air. As such, there are problems with each of these disposal methods.

Improved methods are needed for capturing pollutants and for managing the end product of pollutant capture.

### SUMMARY

Various embodiments include a sorbent system including a porous polymer material at least one active chemical group bound to an outer surface of the porous polymer material and within the porous polymer material wherein. In some embodiments, the porous polymer material is a foam, such as a polyurethane. In some embodiments, the porous polymer is a fibrous polymer sheet, such as a polyamide. In some embodiments, the sorbent also includes at least one active chemical group such as at least one of amines, thiols, and alcohols. The active chemical groups may be hydrophobic.

Other embodiments include a sorbent system including a porous polymer material, nanoparticles bound to an outer surface of the porous polymer material and within the porous polymer material, and at least one active chemical group bound to the nanoparticles. The nanoparticles may include one or more metals or metal oxides, for example. In some embodiments, each of the plurality of nanoparticles has a diameter between 1 nm to 500 nm. The nanoparticles may include one or more of titanium, iron, manganese, zinc, silicon or oxides or hydroxides thereof. The at least one active chemical group may be one or more amine, thiol, or alcohol. The active chemical groups may be hydrophobic. In some embodiments, the porous polymer material is a foam such as polyurethane. In some embodiments, the porous polymer is a polyamide.

Other embodiments include methods of desorbing bound persistent organic compounds from a sorbent. In some embodiments, such methods include adding a sorbent to a vessel, the sorbent comprising a porous polymer with one or more persistent organic compounds bound to the sorbent, adding a solvent solution to the vessel, the solvent solution comprising an organic solvent and an organic base, and passing the solvent solution through the sorbent in the vessel to release the bound persistent organic compounds from the sorbent into the solvent solution. In such embodiments, the persistent organic compound may be a perfluoroalkyl substance or a polyfluoroalkyl substance, for example. The organic solvent may be an organic acid or an organic alcohol. In some embodiments, the organic solvent may be methanol, ethanol, and isopropanol. The sorbent may be a foam, such as polyurethane. The step of passing the solvent through the sorbent in the vessel may include mechanically compressing and releasing the polyurethane foam in the solvent solution. The vessel includes an interior surface that, in some embodiments, is coated with long chain organic molecules, such as a long aliphatic or branched chain organic acid or alcohol.

Other embodiments include methods of destroying captured persistent organic compounds. In some embodiments, such methods include passing a solvent solution through a sorbent having a bound persistent organic compound to release the persistent organic compound into the solvent solution, concentrating the released persistent organic compound, and applying energy to the released persistent organic compound to destroy the persistent organic compound. The energy may include acoustic cavitation, for example, which may have a frequency of about 200 kHz to about 1000 kHz, such as about 850 kHz, for example. The persistent organic compound may be a perfluoroalkyl substance or a polyfluoroalkyl substance. Destroying an persistent organic compound such as these may include defluorinating the persistent organic compound. The energy may be a locally applied energy. Examples of locally applied energy in various embodiments include UV energy, electrical energy, or energy under supercritical conditions. The step of concentrating the released persistent organic compounds may include evaporating the solvent solution. For example, evaporating the solvent solution may include at least one of heating the solvent solution and evaporating the solvent solution under vacuum. The method may also include suspending the concentrated persistent organic compounds in water prior to applying destructive energy.

Other embodiments include methods of capturing persistent organic compounds present in a liquid. The method includes passing a contaminated liquid containing a persistent organic compound through a sorbent, the sorbent comprising a porous polymer with bound active chemical groups on a surface of the porous polymer and within the porous polymer. The porous polymer may be a polyurethane foam. In some embodiments, the method also includes, prior to passing the contaminated liquid through the sorbent, exposing the polyurethane foam to a solvent to increase binding capacity of the sorbent. The solvent may be methanol and ammonium hydroxide, for example.

Still other embodiments include a method of activating a porous polymer material including, prior to capturing an organic pollutant, cleaning and activating a porous polymer material by passing a first polar protic solvent through the porous polymer material to remove impurities and free up preexisting functional groups, capturing at least one organic pollutant with the cleaned activated porous polymer, passing a second polar protic solvent through the porous polymer to release the at least one captured organic pollutant from the porous polymer into the second polar protic solvent, evaporating the polar protic solvent containing the released at least one captured organic pollutant to concentrate the at least one organic pollutant, destroying the concentrated at least one captured organic pollutant. In such embodiments, the first and second polar protic solvents may be the same solvent or may be different solvents. The porous polymer material may be a foam such as polyurethane. The step of destroying the concentrated at least one captured organic pollutant may include applying acoustic cavitation energy to the at least one captured organic pollutant.

Other embodiments include apparatuses for the destruction of captured pollutants. In some such embodiments, the apparatus includes a vessel including vessel wall with an interior surface enclosing an interior space coated with a long chain organic molecule, a first inlet in fluid communication with a reagent supply, a second inlet in fluid communication with a source of desorbed pollutant in a solvent, and an outlet, and an energy source configured to direct energy into the interior space, the energy comprising one or more of ultrasound energy at a frequency of about 200 kHz to about 1000 kHz, UV energy at about 100 nm to about 400 nm, and/or visible light at about 400 to about 700 nm.

Other embodiments include systems for destroying captured pollutants. In some such embodiments, the system includes a first vessel comprising a desorption vessel including a vessel wall defining an interior space, one or more inlets configured to receive a sorbent containing captured pollutant and a solvent, and an outlet and one or more mechanical elements to cause flow of the solvent through the sorbent to facility desorption of the pollutant from the sorbent into the solvent, a second vessel comprising a concentration vessel including a vessel wall defining an interior space, an inlet and an outlet and apparatus for concentrating or evaporating the solvent in the interior space, and a third vessel comprising a destruction vessel including a vessel wall defining an interior space, an inlet and an outlet and an energy source configured to direct destructive energy into the interior space. In such embodiments, the first, second and third vessels may be in fluid communication such that, after the captured pollutant is released from the sorbent in the desorption vessel, it flows from the outlet of the first vessel to the inlet of the second vessel and into the second vessel, and then from the outlet of the second vessel to the inlet of the third vessel and into the third vessel.

In some embodiments, the sorbent system includes a porous polymer material and a plurality of nanoparticles bound to an outer surface of the porous polymer material and within the porous polymer material. The plurality of nanoparticles may have a diameter between 1 nm to 500 nm. The nanoparticles may include titanium, iron, manganese, zinc, silicon or oxides and hydroxides thereof. In some such embodiments, the sorbent system further includes at least one active chemical group bound to the nanoparticles. The at least one active chemical group may include at least one of amines, thiols, and alcohols. In some embodiments, the active chemical groups are hydrophobic.

### BRIEF DESCRIPTION OF THE DRAWINGS

While the specification concludes with claims particularly pointing out and distinctly claiming the subject matter that is regarded as forming the various embodiments of the present disclosure, it is believed that the disclosure will be better understood from the following description taken in conjunction with the accompanying Figures, in which:

FIG. 1 is a method of PFAS capture and destruction according to various embodiments;

FIG. 2 is a method of contaminant, desorption and destruction according to various embodiments;

FIG. 3 is a schematic representation of a system for contaminant, desorption and destruction according to various embodiments;

FIG. 4 is a schematic representation of an alternative system for contaminant, desorption and destruction according to various embodiments;

FIG. 5 is a schematic representation of another alternative system for contaminant, desorption and destruction according to various embodiments;

FIG. 6 is a schematic representation of another alternative system for contaminant, desorption and destruction according to various embodiments;

FIG. 7 is a working example of a contaminant, desorption and concentration system comprised of a solvent extraction vessel and a rotary evaporator;

FIG. 8 is a Fourier transform infrared analysis result of a polyurethane support material before and after treatment with PFOA;

FIG. 9 is a general structure of a urethane bond;

FIG. 10 is a photograph of the contact angle measurement for a polyurethane foam;

FIG. 11a is a graph of the loading capacity for PFOA and PFOS for an activated porous polyurethane nanocomposite;

FIG. 11b is a graph of the loading capacity of an activated porous polyurethane nanocomposite as compared to other sorbent technologies;

FIG. 11c is a graph of experimental sorption kinetic data for PFOA and PFOS;

FIG. 12 is a graph of breakthrough curves of PFOA for granular activated carbon and an activated porous polyurethane nanocomposite;

FIG. 13 is a graph of sorption of PFOS from reagent water with uncleaned and cleaned an activated porous polyurethane nanocomposite;

FIG. 14 is a conceptual scheme of the activated nanocomposite sorbent materials; and

FIG. 15 is a graph of sorption of PFOS and PFOA from reagent water with fibrous polyamide.

### DETAILED DESCRIPTION

This invention describes a process whereby materials that have been utilized for removal of contaminants from water through adsorption or other chemical binding interaction, referred to as sorbents, undergo desorption and recovery and the recovered concentrate of organic contaminants undergoes a post treatment destruction process. The systems and method described herein include the use of a sorbent such as a polyurethane foam with or without a nanocomposite. The sorbent is first used to absorb one or more pollutants from the environment, such as from air or water, such that the pollutant is bound to the sorbent. The pollutant may then be released from the sorbent, the sorbent may be recycled, and the pollutant may be destroyed. In some embodiments in which PFAS is captured, the process may break all of the strong carbon-fluorine bonds such that the PFAS may be generally or completely defluorinated.

Various types of sorbent systems may be used. In some embodiments, the sorbent comprises polyurethane such as polyurethane foam, which may be polyurethane alone, with the polyurethane directly capturing the pollutant. In other embodiments, the sorbent system also includes nanoparticles. In some such embodiments, the sorbent system includes a polyurethane support such as a polyurethane foam with nanoparticles on and within the foam matrix as a nanocomposite. In such embodiments, the polyurethane support matrix may directly capture pollutants while the nanoparticles may also capture the same pollutants and/or other pollutants. In such embodiments, chemical functional groups like amines or quaternary ammonium groups may be bound directly to the polyurethane support matrix or chemically adhered to the surface of nanoparticles on and within the foam matrix.

In some embodiments, sorbents may be comprised of polymer sheets including but not limited to electrospun, wet-laid, melt-blown, and extruded films and fibers. Polymers may include polyamide, nylon, polystyrene, polyurethane and cellulose or combinations thereof. In some embodiments, the polymer could be a fiber. This fiber could be used in filtration as a wound-fiber filter material. In some embodiments, the sorbent includes more than one polymer.

In some embodiments, the nanocomposite is a two phase material including a metal or non-metal nanoparticle on the surface of and within a support matrix. The nanoparticle may have a size in the nanoscale range such as approximately 1 nm and approximately 1000 nm, or between approximately 1 nm and approximately 500 nm, or between approximately 100 nm and approximately 700 nm. In some embodiments, the nanoparticle may be a metal. In some embodiments, the nanoparticle may be a metal oxide such as titanium dioxide. The matrix may be a polymeric matrix, for example. The matrix may be porous, having a sponge-like structure, with the nanoparticles bound to the porous interior and exterior surfaces of the matrix throughout the pores. In embodiments in which the sorbent system is a nanocomposite, the sorbent such as the polyurethane matrix may be a porous matrix which may have pores throughout some or all of it in the nature of a sponge. The matrix may function as a support structure for the metal or non-metal nanoparticles bound to its surface. In some embodiments, the particles may be one or more metals or metal oxides or hydroxides such as copper, iodine, silver, tin, zinc, titanium, selenium, nickel, iron, cerium, zirconium, magnesium, manganese, silicon, copper oxide, titanium dioxide, iron oxide and zinc oxide, non-metals such as selenium and carbon, including graphene, graphite and their oxides, or combinations of more than one of these or other nanoparticles or alloys thereof. The metal, non-metal and metal oxides and other compositions may be used alone or in combination or may be omitted.

Sorbent systems including nanoparticles useful in various embodiments may be created using a thermal reduction process to create nanocomposites of metallic or non-metallic nanoparticles bound within a matrix. The particular nanoparticles and matrix used may be selectively tailored to improve adsorption and diffusion of one or more specific pollutants such as PFAS, as well as for their use in degradation of the pollutants after capture.

In some embodiments sorbent systems may contain active chemical groups that are bound to the surface and bulk of the sorbent either through direct interaction with the sorbent or adhered to nanoparticles previously bound within the matrix. Such chemical groups include but are not limited to nitrogen containing (amine) compounds including primary, secondary, tertiary and quaternary and conjugated polymers containing these compounds, sulfur containing (thiol) compounds, and oxygen containing (alcohol) compounds. Other chemical groups include hydrophobic compounds including but not limited to compounds with long hydrocarbon chains such as lipids, conjugated sugars, fluorinated hydrocarbon chains, and fatty alcohols as well as hydrophobic aromatic compounds such as alkylbenzenes and aromatic polymers.

The inclusion of active chemical groups may provide for improved absorption of PFAS. For example, quaternary ammonium groups provide a stable positive charge to the surface of the sorbent material. This charge attracts negatively charged short chain PFAS molecules such as perfluorobutanoic acid and allows for improved capture as compared to a sorbent that does not contain these groups. Utilizing charge based interactions in addition to a hydrophobic interactions allows the sorbent to capture a broader range of PFAS compounds, both long and short-chain.

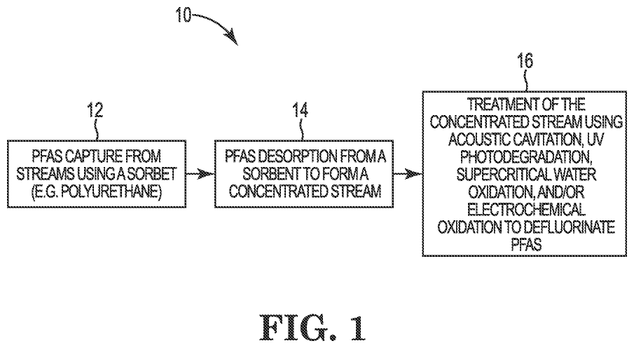

One process for PFAS capture and defluorination according to various embodiments is shown in FIG. 1. In this example, the process 10 includes three major steps. In step 12, PFAS is captured from streams using a sorbent such as polyurethane. Then in step 14, the process includes desorption of the captured PFAS from the sorbent to form a concentrated stream. In step 16, the concentrated stream is treated using acoustic cavitation, UV photodegradation, supercritical water oxidation, and/or electrochemical oxidation to defluorinate the PFAS. In this way, the PFAS is captured using a sorbent, it is removed from the sorbent so that the sorbent may be reused for further PFAS capture. In addition, the captured PFAS is defluorinated to eliminate waste disposal concerns. Details of these steps are discussed further below.

While PFAS is a major environmental concern and is a particular focus of this disclosure, the processes described herein are not limited to PFAS but rather may be applied to other pollutants as well. Any type of compound which binds to the sorbent system may be bound, removed, and degraded using the sorbent systems and processes described herein. Examples of compounds which may be captured and destroyed include various chemicals, pollutants or contaminants. These include, for example, organic compounds such as perfluoroalkyl and polyfluoroalkyl substances, biological toxins, polycyclic aromatic hydrocarbons (PAHs), hormones, antibiotic compounds, and volatile organic compounds (VOCs). Some embodiments may be capable of absorbing more than one pollutant simultaneously. Examples of PFAS which may be bound, removed, and destroyed according to various embodiments include synthetic organofluorine compounds where all or some of the hydrogen atoms in the alkyl chain are replaced by fluorine. Specific examples include perflurooctanoic acid (PFOA) and perfluorooctanesulfonic acid (PFOS).

The compounds captured by the sorbent system may be present in water or air in the environment, for example. The sorbent system may be used to remove the compounds from water at a water treatment plant or within surface or underground bodies of water such as lakes, rivers, groundwater and wells, for example. However, in some embodiments, removal of these compounds may occur prior to expulsion into the environment, such as in an industrial setting like in flu gas prior to or during release or in wastewater prior to or during expulsion from an industrial plant, such that the pollutant is never released or the release is minimized, or during a manufacturing process such as a chemical manufacturing process. Thus, while this disclosure refers to the captured compounds as pollutants, it extends to other compounds which never become pollutants or are not typically pollutants but for which there is a need to capture and remove them from a liquid or gas in which they are present.

The sorbent systems may be deployed in a liquid or gas system, such as a water or air system, such that the liquid or gas flows or is pumped around and/or through the sorbent and the pollutant binds to the sorbent. During passage through the sorbent system, the pollutant molecules become captured and bound to the sorbent. This capture may occur through a bonding between the pollutant and the sorbent such as the polymer like polyurethane and/or to the nanoparticles and/or active chemical groups if present in the sorbent system. For example, there may be electrostatic interactions between pollutants such as PFAS and alcohol and carboxylic acid functional groups of a polyurethane matrix or other polymer matrix. There may be hydrophobic interactions between non-polar PFAS and the nanocomposite and surface binding to the nanoparticles in the composite. There may be charged-based interactions between negatively charged PFAS compounds and positively charged active chemical groups on the sorbent. Other bonding interactions may also occur. Once the sorbent system is loaded with one or more pollutants, the sorbent may be removed from the liquid or gas into which it was deployed. The pollutant is now firmly bound to the sorbent. In this way, the pollutant is partially or completely removed from the liquid or gas.

In some embodiments, the sorbent may be tightly packed into a cylindrical cartridge for filtration. Water or air is then allowed to flow into this cartridge in a controlled manner allowing for a set contact time of the water or air being treated at the sorbent. In other embodiments, the sorbent is a flat sheet that is wound around a central dispersion point. Water or air is then allowed to flow into the cartridge whereby it flows out radially through the sorbent for a set contact time.

In some embodiments, aromatic polyurethane foam may be used as the sorbent. For example, it was discovered that commercially available aromatic polyurethane foam has a high affinity for PFAS removal, particularly for perfluorooctanoic acid (PFOA) and perfluorooctanesulfonic acid (PFOS). Such foams are currently used in bedding materials and upholstery.

Polymer foams such as polyurethane foam have several advantages for use in sorption. The open cell structure of the foam includes micro sized pores which allow for water to pass through the material and come into contact with the hydrophobic layers. In addition, polymer foams such as polyurethane foam have a low density which allows the material to be compressed into reactor vessels and keeps disposal costs low due to the lightweight nature of the foam. An example of material properties of the polyurethane foam which may be used in various embodiments are shown in Table 1, below.

TABLE 1
Relevant physical properties of polyurethane foam

| | | | Water Contact |
|---|---|---|---|
| Material | Pore Size (μm) | Density (g/cm³) | Angle (degrees) |
| Polyurethane | ~200 | 0.046 | 140 |
| Foam | | | |

Chemically, polyurethane foam is an ideal sorbent product for PFAS in that it is highly hydrophobic and has unique chemical functional groups that enable PFAS binding including specific chemical functional groups inherent to urethane bonds including amines and carbonyl groups in the urethane bond. By analyzing the sorbent before and after the addition of the target PFAS compound, information can be gained on the mechanism of sorption between the target and the sorbent. Experimental results discussed in the experimental section indicate that electrostatic interactions occur between PFAS compounds and oxygen present in alcohol and urethane groups, carbon present in methyl functional groups, and in the urethane functional groups of the polyurethane support. Sorption of PFAS compounds by the polyurethane also occurs with the formation of C—F bonds.

Polyamide polymers, such as nylon, are also ideal sorbent products for PFAS in that it is highly hydrophobic and has unique chemical functional groups that enable PFAS binding including specific chemical functional groups inherent to the amide bonds including secondary amines, tertiary amines and carbonyl groups. Additionally, nylon can be formed into thin fibers with high reactive surface area. This surface area enables more binding sites for PFAS interactions. Other polymers that contain amine groups will also exhibit preferential binding to PFAS compounds.

Sorbents having hydrophobic surfaces and those having a contact angle of 90 degrees or more may be used in various embodiments. Polyurethane foam exhibits an average contact angle of 140±5 degrees. This hydrophobicity is important as PFAS compounds are drawn to hydrophobic surfaces. In general, hydrophobic materials with a contact angle of 90 degrees or more will exhibit preferential sorption for hydrophobic compounds like PFAS.

Various embodiments include the use of sorbents having a high loading capacity. Having a high loading capacity is important as the higher the loading capacity, the longer the material can be utilized before it must be replaced, reducing maintenance costs and the overall footprint of filtration installations. It has been discovered that polyurethane has a high loading capacity, particularly for PFOA and PFOS. For example, the loading capacity of polyurethane in mg of PFOA/PFOS adsorbed per mg of sorbent is nearly 30 times that of activated carbon.

Various foams materials or other porous materials may be used as sorbents and the inventions are not limited to polyurethane foams. For example, any foam or porous polymer that has a hydrophobic surface with a static water contact angle over 90 degrees, preferably over 120 degrees, may be used in some embodiments. The composition of a sorbent material such as a foam which may be used in various embodiments may include a combination of one or more of the following: hydrophilic charged functional groups (such as amines-NH, aldehyde —C═O and aromatic groups, urethane group-NH—(C═O)—O—) that offer electrostatic interactions with PFAS; hydrophobic chemical functional groups (such as methyl —CH₂ or ethyl-CH₃ groups) that capture PFAS through hydrophobic interactions, and/or aromatic group that capture PFAS through anion-Pi interactions. The pore size of the sorbent may range from about 5 nanometers to about 5 millimeters, in some embodiments.

Examples of other foams that may be used in embodiments of the present disclosure include, but are not limited to, melamine, polyamides, nylons, polyester, polystyrene, polyethylene-vinyl acetate foams, ethylene vinyl alcohol, polyvinyl alcohol, polycaprolactone, and/or polylactic acid, foams and porous materials made from or functionalized with lycopodium spores or powders, and other conjugated or composite foams.

In some embodiments the sorbent may be a polymer sheet, such as a polymer sheet comprised of fibers. The fibers may have in a range of sizes between about 0.1 and about 5 micrometers, for example. These fibers may include, but are not limited to, one or more of cellulose, polyester, polypropylene, polyamide, nylon, and polyurethane.

Like the polymer foams discussed above, the sheets such as fibrous sheets may be used as sorbents in sorbent systems that may include nanocomposites and/or active chemical groups. As such, the sorbent system may contain active chemical groups that are bound to the surface and within the bulk of the sorbent sheet either through direct interaction with the sorbent or the active chemical groups may be adhered to nanoparticles previously bound on and within the matrix. Such chemical groups may include but are not limited to amine compounds including primary, secondary, tertiary and quaternary and conjugated polymers containing these compounds. For example, the polymer foam may include an amine as an active chemical group. In some embodiments, the polymer foam may include a thiol as an active chemical group. In still other embodiments, the polymer foam may include an alcohol as an active chemical group. Other chemical groups that can be included in the sorbent system include hydrophobic compounds including but not limited to compounds with long hydrocarbon chains such as lipids, conjugated sugars, fluorinated hydrocarbon chains, and fatty alcohols as well as hydrophobic aromatic compounds such as alkylbenzenes and aromatic polymers. These compounds allow for tunable surface interactions driven by hydrophobic interactions between the sorbent and the pollutant.

The active chemical groups introduce variable, tunable surface charge into the sorbent material that enable specific capture of charged pollutants from water. A tunable surface charge is defined here as a charge that be controlled through the introduction of various active chemical groups. For example, a primary amine can be fully protonated and carry a positive charge under certain pH conditions. By controlling both the amount of position of these chemical groups, the surface charge of the sorbent can be controlled.

Furthermore, the active chemical groups provide a tunable surface charge that can be reversed when desired for pollutant recovery and concentration. Using the example of a primary amine, by increasing the pH around the sorbent using a base, the amine will lose a proton and, consequently, lose its positive charge. Hence, all bound pollutants that relied on that positive charge will be released.

In some embodiments, the sorbent such as polyurethane may be treated to improve sorption, such as though a process which may be called “activation.” This process may allow for the removal of any bound organic material in the sorbent, including PFAS traces and other hydrophobic compounds, and may liberate more sorption sites for PFAS within the sorbent, improving the amount of PFAS that can be captured in the foam. The sorbent may be activated prior to the first use for PFAS sorption and/or activation may be repeated after PFAS desorption and prior to reuse of the sorbent. In various embodiments, activation of the polyurethane allows the PFAS reduction or removal of traces and other organic contaminants present in the foam such as during foam manufacturing or prior to reuse as a sorbent. As a result, the activation process frees new sites for interaction with PFAS contaminants and thus increase the removal capacity of polyurethane for PFAS compounds.

To obtain an activated sorbent such as activated polyurethane, the sorbent such as the sheet or the foam such as the polyurethane foam may be exposed to a solvent and an organic base, such as a solvent combination of methanol and ammonium hydroxide. In some embodiments, the solvent is a polar protic solvent. In some embodiments, the sorbent such as polyurethane foam may be exposed to about 80-100% methanol and about 0.5-10% ammonium hydroxide by volume. In one example, the sorbent such as polyurethane foam may be exposed to 95% methanol and about 5% ammonium hydroxide to form activated polyurethane for use as a sorbent. The solvent may then be removed from the sorbent and the activated sorbent may be used (or may be used again) for PFAS capture. In this way, PFAS capture may be improved as compared to the same sorbent which has not been activated prior to PFAS capture.

In some embodiments, the sorbent system includes a matrix such as a sheet of foam matrix like a polyurethane foam matrix coated with nanoparticles. One process for creating such sorbent systems includes a thermal reduction process which may be referred to as thermal crescoating, through which nanoparticles may be grown on and throughout a porous support material such as polyurethane foam. In one example, the process may include three steps. The first step may be wet impregnation of a porous or fibrous matrix material with a metal or non-metal ionic precursor (such as ferrous sulfate, ferric chloride or titanium chloride) under appropriate conditions such as concentration, hydration, pH and zeta of the matrix material. The next step may be evaporation of the solution, such as through heating the impregnated matrix in an oven, to initiate thermal reduction and crystallization of the nanoparticles onto the surface of and within the porous material. The third step may be washing and drying of the sorbent material. This is just one example of a process that may be used, and the process may be modified and/or additional steps may alternatively be included. The end result of such processes are sorbent systems having exceptional surface-to-volume ratios which enable ultra-high pollutant loading capacities and which may be further used for efficient pollutant degradation.

Active chemical groups can be added to the sorbent through employing direct interactions between functional groups on the sorbent or through interactions with nanoparticles embedded in the sorbent. For example, a molecule containing a primary amine on one end and a linking group on the either may be added directly to the sorbent. Examples of linking groups include siloxanes that can spontaneously bind to alcohol and carbonyl groups present in the sorbent. Another example of linker chemistry is the use of common linking agents such as 1-Ethyl-3-(3-dimethylaminopropyl) carbodiimide (EDC) and N-hydroxysuccinimide (NHS) to create bonds between carboxylate groups in a molecule and amide groups in the sorbent. Additionally, many chemical groups such as siloxanes and thiol groups can be used as linkers as they will spontaneously bond to nanoparticle surfaces. To facilitate these interactions, the sorbent is added to an aqueous or an organic solvent solution containing the molecule to be added and the appropriate linker groups. This solution may then be mixed, heated or dried depending on the type of linker chemistry employed.

The contaminant may be captured by the sorbent in various ways. In some embodiments, a contaminant stream may be introduced into a column system including the sorbent system. The column system may be gravity fed, or stream may be introduced using a pumping system. In some embodiments, the sorbent may be periodically compressed and released, optionally repeatedly, to enable faster flows and faster diffusion of the contaminants inside the sorbent. When the sorbent is a foam, it may be one or more large pieces of foam or may be numerous small pieces. In some embodiments, the foam sorbent may be shredded into numerous small pieces, or may be in the form of multiple thin film/membranes. In some embodiments, the sorbent may be in the form of sheets or fibers which may be wound around a central water dispersion unit. This central dispersion unit typically is a hollow cylindrical tube with perforations to allow for water to flow radially outward through the sorbent that is tightly wrapped around it in a manner to control porosity and maximize contact time. In some embodiments, the sorbent may be in granular form.

Once the PFAS or other target pollutant is bound to the sorbent, the PFAS or other target pollutant-laden sorbent may be referred to as a used or depleted sorbent. The captured PFAS may be removed from the used sorbent by various methods. In some embodiments, PFAS de-sorption may be caused by solvents. For example, in some embodiments, such as when polyurethane is used as the sorbent, the interaction between the sorbent and the captured PFAS may be reversable. For example, after capture of PFAS by the sorbent, the sorbent may be washed with the solvent to release the PFAS.

In various embodiments, such as those that use polyurethane for PFOA and/or PFOS capture as well as other sorbents described herein, the interaction between sorbent such as polyurethane and PFOA/PFOS may be reversible in the presence of a high concentrations of organic solvents. In some embodiments, the solvent may be a polar protic solvent. Ideal solvent categories for this process include water miscible organic solvents. Particular example classes include nitriles, alcohols and ethers. Example of water miscible nitriles include acetonitrile. Water miscible alcohols that may be used for desorption of the PFOA and/or PFOS including but not limited to methanol, ethanol, and isopropanol. For example, in some embodiments, methanol may be used for desorption of the PFOA and/or PFOS as described herein. IN other embodiments, ethanol may be used for desorption of the PFOA and/or PFOS as described herein. IN still other embodiments, isopropanol may be used or desorption of the PFOA and/or PFOS as described herein. Some non-water miscible solvents like hexane may also be used. For example, after PFAS capture by a sorbent such as polyurethane foam, the polyurethane may be thoroughly washed with an organic solvent for a period 1-15 minutes to de-sorb the PFAS compounds. In some embodiments, the polyurethane may be washed with the organic solvent for approximately 5 minutes. The amount of organic solvent needed for removal of the captured PFAS from the sorbent may be the minimal volume needed to fully wet the sorbent. This de-sorption process can be performed once or may be repeated multiple times, such as up to five times to increase de-sorption performance. In some embodiments, the process is performed two times.

Inorganic acids or bases such as ammonium hydroxide, sodium hydroxide, hydrochloric acid, and nitric acid may be added to the organic solvent to improve removal of PFAS that are bound by charge-based interactions. These acids and bases may be added directly to a dilute solution of the organic solvent and water. For PFAS bound to primary amine groups in the sorbent, increasing the pH of the solvent used for extraction effectively de-protonating these chemical groups, removing the positive charge, and releasing the bound PFAS.

Desorption of the PFAS from the sorbent creates a concentrated stream which remains toxic and must be managed. In various embodiments, the concentrated stream of PFAS may be defluorinated. It is important to make a distinction between degradation and defluorination of PFAS compounds. Degradation refers to the decomposition of long carbon chain PFAS compounds like PFOA and PFOS into shorter chain fluorocarbons through the cleavage of the carbon-carbon bonds. These short chain fluorocarbons present issues as their environmental mobilities have not been studied in detail. Furthermore, recent research by the US National Toxicology Program suggests that PFAS compounds with five carbon chain and lower present similar liver and thyroid issues as longer chain PFAS compounds. In contrast, defluorination refers to the breakdown of the very strong carbon-fluorine bond which results in final non-toxic products of water, carbon dioxide and fluoride (F⁻) ions. Various embodiments include processes for defluorination including defluorination for the remediation of PFAS compounds to prevent the release of PFAS as well as potentially toxic short chain PFAS compounds.

Destruction includes a change in the identity of the target chemical pollutant through the cleavage of chemical bonds. Destruction that yields complex chemical compounds as final products is referred to as degradation. Degradation in the case of PFAS means that larger PFAS compounds consisting of 6 carbon chains or longer are broken down into short chain PFAS compounds consisting of 5 carbons or fewer. In the case of PFAS compounds, the cleavage of the carbon fluorine bond to produce carbon dioxide, fluoride and water, is hereto referred to here as defluorination.

Destruction includes removing one or more chemical groups to reduce or eliminate toxicity. In some embodiments, the present disclosure includes methods and systems where persistent organic compounds including per- and polyfluoroalkyl substances are captured by sorbent systems including porous polymeric polyurethane foam and other polymer matrices. Alternatively, or in addition, the present disclosure includes methods and systems whereby the compounds captured in the sorbent systems including polymer foam matrices are recovered using organic solvents and organic bases into concentrated waste streams. The methods and systems may also include destroying the concentrated waste streams via cavitation using a acoustic cavitation device or ultraviolet light assisted photocatalysis system.

After the extraction of the target pollutant from the sorbent with the solvent, the solvent removal may be removed in order for the extracted target pollutants to be concentrated. Solvent removal can be achieved through a number of processes including, but not limited to, one or more of evaporation by heating, pressure or other method, centrifugation, settling, and/or filtration.

Once the PFAS materials are concentrated into a small volume waste stream a method of PFAS defluorination can be implemented. Various methods may be used for destroying the concentrated PFAS or other concentrated pollutant. In some embodiments, energy may be applied to the concentrated PFAS and/or other concentrated pollutant. For example, ultrasound energy may be used to destroy the PFAS and/or other concentrated pollutants. In other embodiments, UV energy may be used to destroy the PFAS or other concentrated pollutants. In other embodiments, electrical energy may be used to destroy the PFAS and/or other concentrated pollutants. In still other embodiments, other supercritical conditions may be used to destroy the PFAS and/or other concentrated pollutants.

In some embodiments, PFAS defluorination may be performed through the use of a free radical generator, such as sodium persulfate, alone or in combination with the application of energy such as acoustic cavitation or ultraviolet light in the presence of a catalyst such as a radical generator or hydrated electron generator. A free radical generator facilitates the creation of radicals: a highly reactive atom containing one or more unpaired electrons. Hydrated electrons are highly reactive free electrons that are encased in water molecules. For PFAS destruction and defluorination, both radicals and hydrated electrons attack and cleave the carbon-fluorine bonds. In one example, the concentrated volume of PFAS may be placed in a container such as a polypropylene bottle and submerged in an ultrasonicator reactor chamber. A free radical generator such as sodium persulfate or hydrogen peroxide may be added to the solution of PFAS compounds. The concentration of the free radical generator may vary. For example, the concentration of sodium persulfate in the mixture may be from about 1 g/L to about 5 g/L. This mixture may then be exposed to energy treatment such as acoustic cavitation. Various parameters may be used. For example, acoustic cavitation energy having a sonication frequency of about 200 kHz to about 1000 kHz may be applied, such as a sonication frequency of about 850 kHz. In some embodiments, the energy may be applied continuously or intermittently. For example, the sonication frequency used in acoustic cavitation may be 862 kHz for 60 minutes under a pulse mode whereby the sample may be treated intermittently for 100 ms on and 100 ms off. The sample temperature may be kept between 25 degrees Celsius and 40 degrees Celsius. In some embodiments, a higher temperature may be preferred for better performance. In other embodiments, a sweep mode may be used for sonication, such as by alternating between high (such as about 600 kHz to about 1000 kHz) and low frequency (such as 200 kHz to about 600 kHz) within a short period of time. For example, a frequency sweeping between 862 kHz and 358 kHz within 1000 ms may be used for the procedure. In other embodiments, the reaction parameters are the same or may be different, and a gas such as Argon may be continuously flowed into the reactor during sonication. Other gases that can additionally or alternatively be used, alone or in combination, include nitrogen and xenon. These gasses are added to the reaction to remove gasses, including oxygen, that would otherwise consume the generated radicals or hydrated electrons.

Acoustic cavitation may be used in this and in various other embodiments. In some cases the acoustic cavitation may alternate between a high and a low frequency within relatively short periods of time, such as from about 0.05 to about 1 second. In some embodiments, a “high” range may be, for example, from about 750-900 kHz, and the “low” range may be, for example, from about 200-350 kHz. In other embodiments the time period may be longer or shorter and the frequency variations may be greater or less, or within greater or lesser ranges.

In some embodiments, PFAS destruction may be achieved by the application of ultraviolet light to the concentrated solution. Ultraviolet light may be applied in the presence of a reagent such as a radical generator such as potassium persulfate, a reducing agent or a hydrated electron generator such as potassium iodide which may be referred to as UV photocatalysis. PFAS destruction may be achieved through the application of ultraviolet light in a wavelength of 100-400 nm for a period of 10 minutes to 72 hours, for example.

It is believed that PFAS defluorination may happen as a result of two factors: the reactive oxygen species generated in the solution, and the high temperature and shockwaves created by the cavitation. When exposed to ultrasonic irradiation, liquids undergo acoustic cavitation, which is the formation, growth, and implosive collapse of air/vapor bubbles in the liquid. Bubble collapse during cavitation generates transient hot spots responsible for emission of light and high-energy chemistry reaching around 5000 degrees Celsius (reference: DOI: 10.1126/science.253.5026.1397). This high energy environment facilitates chemical reactions and defluorination of PFAS into carbon and fluorine. Additionally, photocatalytic processes drive the release of excited electrons or radical species including oxygen. These reactive species then facilitate the cleavage of chemical bonds.

Destruction of the pollutant may occur through the application of energy to the pollutant, such as through photochemical, sonochemical, electrochemical, thermochemical, supercritical water oxidation or plasma treatment, alone or in combination with these or other treatment methods. For example, energy may be applied as light such as visible or UV light, plasma, electrons, sonication, heat, or other types of energy. In some embodiments, light in the visible and/or ultraviolet wavelength range may be applied, such as between about 180 and about 700 nanometers, or between about 185 and 260 nm, for a length of time needed for the reaction to complete.

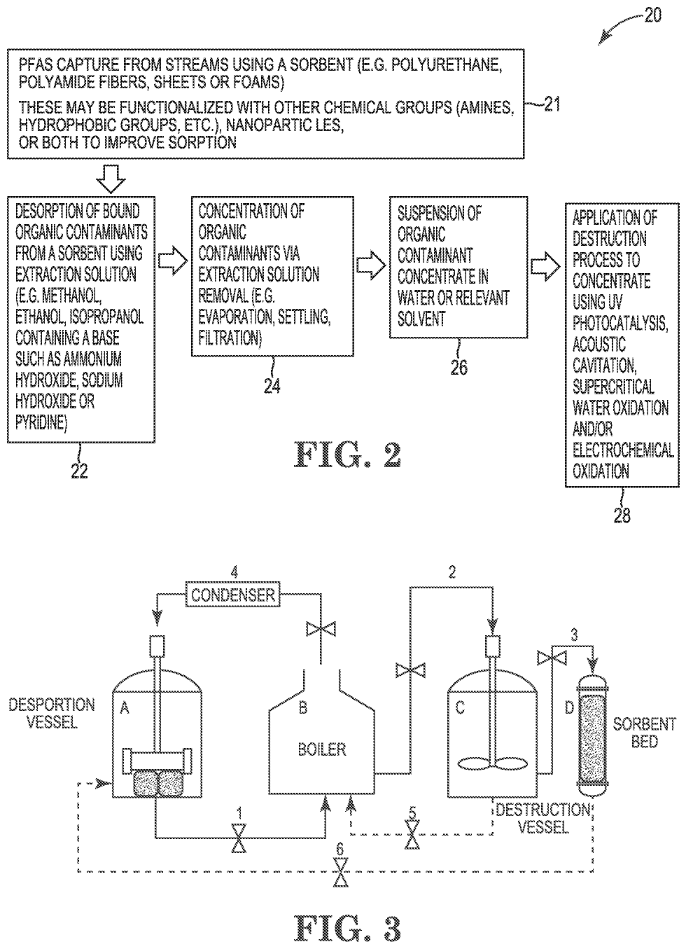

Further details of how the used sorbent may be recovered and how the contaminants may be concentrated and destroyed according to various embodiments are shown in FIGS. 2-7. The figures are shown in a representative, schematic form. As such, while they include some components of a system, other components which are known in the art such as tubing, pipes, pumps, valves, or other conveyor systems and other equipment may be used for performing the various steps, such as for transporting the fluids and other materials as shown by the arrows, collecting the gases, etc.

FIG. 2 depicts a process 20 for capture and desorption of bound contaminants and destruction of the contaminant concentrate. In step 21, PFAS is captured from a stream using a sorbent. The sorbent may include polyurethane, polyamide fibers, sheets or foams, for example. In step 22, an extraction solution is used for desorption of the bound organic contaminants from the sorbent. The extraction solution may include an organic solvent such as methanol, ethanol, or isopropanol, for example, and a base such as ammonium hydroxide, sodium hydroxide, or pyridine, for example. Other methods or materials may alternatively or additionally be used for desorption. After desorption, the contaminants are concentrated in step 24. The contaminants may be concentrated by removal of the extraction solution, such as by evaporation, settling and/or filtration, for example. The concentrated contaminants are then suspended in water or a relevant solvent in step 26. In step 28, the contaminants are destroyed through application of a destruction process such as UV photocataysis, acoustic cavitation and/or supercritical water. Contaminants which may be removed and destroyed by this system include but are not limited to organic contaminants like per and polyfluoroalkyl substances (PFAS), polychlorinated biphenyls (PCBs), pesticides, cosmetics, pharmaceutical, and 1,4 dioxane. Sorbent materials that can be used include but are not limited to activated carbon, ion exchange resin, or polymer foam based sorbents such as foam polyurethane.

FIGS. 3-7 show systems that may be used for concentration and destruction of contaminants. In some embodiments the containment vessels shown in these systems and used in various embodiments may be, but are not limited to, one or more of polyethylene, polypropylene, aluminum, steel, plastic, glass, other metals, non-metals, or polymer containers.

In the system shown in FIG. 3, a spent sorbent material having bound contaminant can be put in Vessel A (Desorption Vessel) that may have the capability and components to perform compression and decompression and/or mixing. An extraction solution containing organic solvents, including but not limited to methanol, isopropyl alcohol, acetonitrile, with or without additives, can be added to Vessel A at a purity of 20% to 100% (v/v), for example. Additives can also be added, including but not limited to ammonium hydroxide, acetic acid, water and sodium hydroxide at concentration of 0.5% to 50% (v/v), for example. In some embodiments, Vessel A may contain a plunger to accelerate the desorption process down to minutes through active compression and release of a compressible sorbent material. In other embodiments, Vessel A may contain a mixing or stirring mechanism that enables desorption from compressible sorbents as well as other sorbent types which may not be compressible.

The concentration of the contaminant of interest in the solution in Vessel A may be continuously or periodically monitored. For example, Vessel A may include a sampling port to monitor the desorption process by measuring the concentration of the contaminant of interest.

Once an adequate or desired level of contaminant de-sorption is achieved, the solution may be transferred from Vessel A to Vessel B. In the embodiment shown in FIG. 3, a valve can be opened after the desorption process in Vessel A to allow the used solvent to pass to Vessel B (Boiler) as shown by arrow 1. Vessel B may contain a heating apparatus that will heat the used solvent in a controlled manner and a gas inlet optionally allowing clean gas, including but not limited to air, nitrogen, and/or argon, to flow into Vessel B to accelerate the evaporation of the used solvent. The heating condition can be between about 40 and about 120 degrees Celsius, for example. The system may include a condenser to recover the evaporated solvent from Vessel B through distillation. The recovered solvent may pass back into Vessel A for use in a subsequent desorption process as shown by Arrow 4. The used solvent containing the released PFAS remaining in Vessel B after evaporation may be completely or almost completely dried prior to the next step.

Once distillation of the solvent is complete or has progressed to a desired stage, such as once Vessel B is completely or almost completely dry, water, including but not limited to distilled water and Grade I reagent water, may be added to Vessel B. Other solvents that may alternatively or additionally be used including oils or hydrocarbon solutions containing hexane, octanol, glycerol, solvent mixtures containing diluted alcohols including isopropanol, methanol, and ethanol such as at a concentration of about 0.5 to about 20% (v/v). These may contain organic or inorganic acids or bases including but not limited ammonium hydroxide, sodium hydroxide, hydrochloric acid, and nitric acid. The water and/or other solvents may redissolve and/or dilute the contaminants left is Vessel B. In some embodiments, the system may include a stirring or a shaking apparatus to facilitate this process.

Once the contaminants have dissolved in the water and/or other solvent, the water and/or other solvent containing the contaminants may be transferred to Vessel C as shown by arrow 2. Vessel C may be a pre-coated destruction vessel. The coating may include but is not limited to lipids, such as octanoic acid, or other non-fluorinated surfactants. Vessel C can be set up in various ways, depending upon the method of destruction which will be used. For example, vessel C may be configured to accommodate various destruction methods that utilize a source of locally applied energy. Examples of locally applied energy which may be used include but are not limited to sonication induced cavitation, alteration of temperature and pressure to induce supercritical water oxidation, laser ablation, photocatalysis, electrochemistry, plasma and/or alternative mechanisms like bioremediation.

Like vessel C, any of all of the other vessels or equipment used in the system may optionally be pre-coated in various embodiments. In some embodiments, the coating may be a coating of long-chain molecules on the interior surface, such as for example, containments, vessels, glassware, plasticware, and the like to prevent the adhesion of per- and polyfluoroalkyl substances onto the walls of containment vessels and other equipment. The long chain molecule may be a long chain organic molecule. In some embodiments, the long chain organic molecule may be a long aliphatic organic acid. In some embodiments, it may be a long aliphatic organic alcohol. In other embodiments, it may be a branched chain organic acid. In still other embodiments, it may be a branched chain organic alcohol.

One method of destruction which may be used in various embodiments includes sonication induced cavitation which may be used for PFAS destruction. In such embodiments, the water and/or other solvent containing the dissolved PFAS may be subjected to ultrasonic waves at a frequency of about 200 to about 10,000 kHz. Additional chemical additives may be added including but not limited to peroxide, persulfate, nitrate, metal/metal oxide and nanoparticles. This method has been demonstrated to effectively destroy PFOS and PFOA to a level of >90% through the cleavage of the carbon-fluorine bond.

In other embodiments, UV irradiation may be used to destroy the contaminants such as PFAS. In such embodiments, the water and/or other solvent containing the dissolved PFAS may be subjected to ultraviolet irradiation in a wavelength range of about 150 to about 400 nm for a period of time such as about 2 hours to about 72 hours. Additional chemical additives may be added including but not limited to radical generating peroxide, persulfate, nitrate, metal/metal oxide and nanoparticles such as iron, iron oxide, and titanium dioxide as well as radical scavenging additives including methanol and isopropanol. Using this methodology, up to 75% of the PFAS may be defluorinated.

The concentration of the contaminant in the Vessel C may be continuously or intermittently monitored. For example, Vessel C man contain a sampling port to monitor the destruction process.

Once destruction has reached the desired level in Vessel C, the final product can optionally be transferred to Vessel D which may include a sorbent, as shown by arrow 3. The product of Vessel C may pass through the sorbent in Vessel D prior to discharge. After absorbing any remaining contaminant, the sorbent in Vessel D may be transferred to Vessel A. Alternatively, the product from vessel C may be passed back to Vessel B as shown by arrow 5 for one or more additional cycles. This would be done if the initial treatment did not defluorinate the PFAS to a desired level and another cycle was determined to be necessary. For instance, in one embodiment, if the initial treatment did defluorinate all the not of P FAS, another cycle would be necessary. Once complete, the product from vessel D may be discharged and the sorbent in vessel D may be recycled by going through the process again, starting at Vessel A as shown by arrow 6

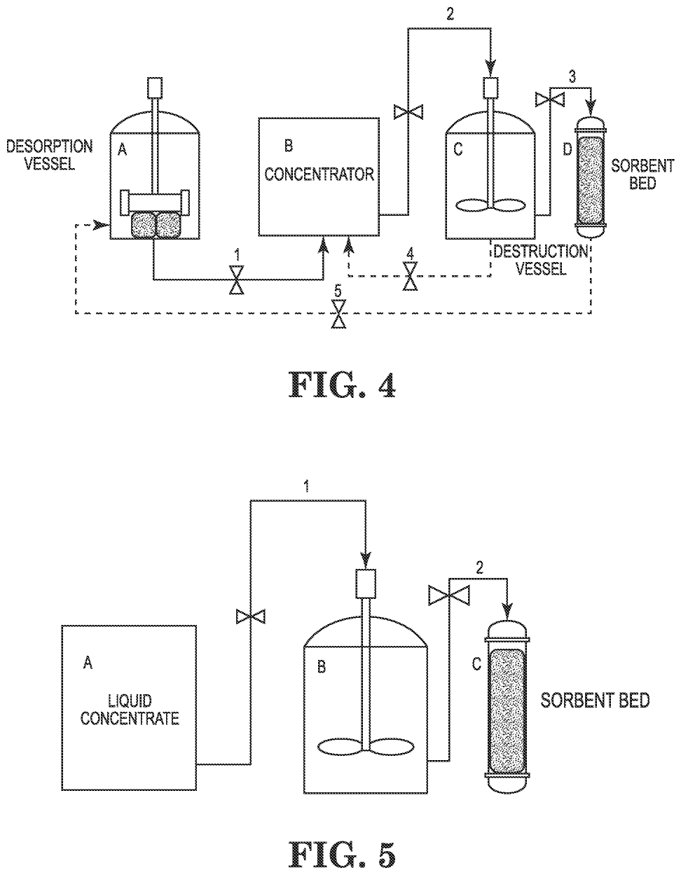

FIG. 4 shows an alternative system for the desorption of contaminant from a sorbent and destruction of the contaminant. The system is like that shown in FIG. 3, except in this embodiment Vessel B is a concentrator instead of a boiler. In this embodiment, the concentrator may use reverse osmosis, dialysis, and/or foam fractionation, for example, to concentrate the contaminants and separate them from the solvent. The concentrated contaminant may then be destroyed in the destruction vessel C and the separated solvent may be reused, such as after additional cleaning, or may be disposed.

FIG. 5 shows another alternative system for the desorption of contaminant from a sorbent and destruction of the contaminant. This system is similar to that of FIGS. 3 and 4 except it omits the vessel indicated as Vessel B in those examples, which was the boiler or the concentrator vessel, respectively. In this embodiment, the contaminants in the solution, from whatever source, are already present at a sufficiently high concentration that a boiler or concentrator are not necessary. For example, this system may be used for solutions when the contaminants are present at a concentration of greater than about 1 milligram per liter. This solution may be directly introduced to Vessel B, which in this example is the destruction vessel, as described in the other examples (in which it was Vessel C). After destruction, the solution may pass to Vessel C, including the sorbent bed, as shown by arrow 2. Alternatively, after destruction in Vessel B, the solution may optionally be cycled back to vessel A as shown by arrow 3, if an addition destruction treatment is desired or needed, for example. Once the solution has passed to Vessel C and after sufficient loading of the sorbent, the used sorbent may then optionally be processed in a desorption vessel in a process such as those shown in FIGS. 3 and 4.

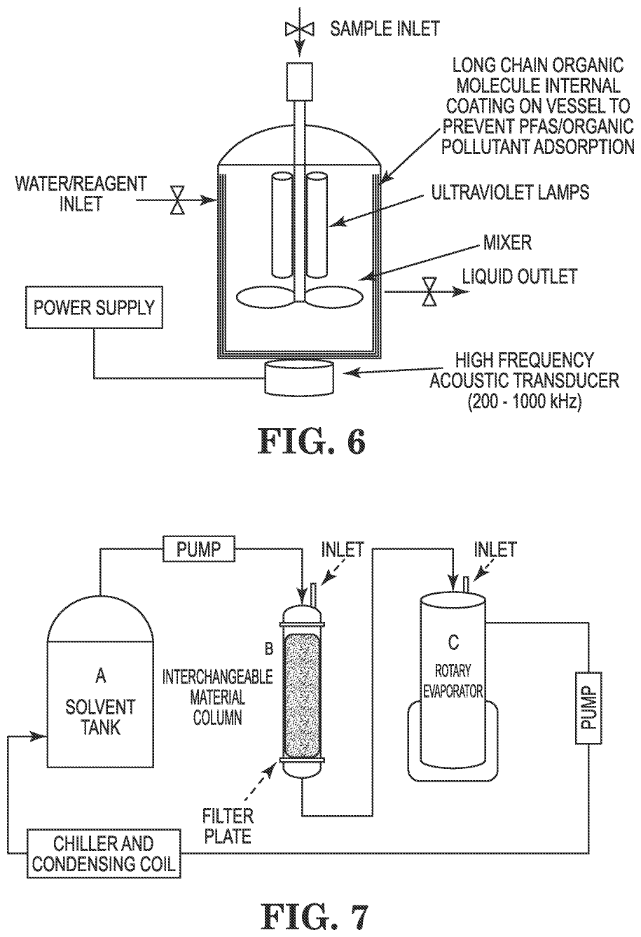

FIG. 6 shows an alternative detoxification system for the destruction of the contaminant which may be used in any of the desorption and destruction system described herein. This system is similar to the detoxification systems shown in FIGS. 3 and 4 except it combines two destruction methods in one detoxification vessel, specifically UV photocatalysis and acoustic cavitation. The detoxification vessel includes an ultraviolet light source, shown inside the vessel along with a mixer, and an acoustic cavitation transducer at the bottom of the vessel and in communication with a power source, though other configurations are possible. The two detoxification processes may be performed simultaneously or sequentially.

FIG. 7 depicts another example of a pollutant concentration system according to various embodiments. This system includes a solvent tank, identified as vessel A, in which a solvent is stored. A pump transfers the solvent to a material column, identified as vessel B, containing the sorbent to desorb bound pollutants. The material column as shown also includes a first inlet for the solvent and a second inlet for water, rinse solution, or other material, at the top and a filter plate and outlet at the bottom, though other configurations are possible. The second inlet for water or rinse solution enables rinsing of the sorbent. After releasing the pollutant from the sorbent, the solvent rinsate then flows into a rotary evaporator, identified as vessel C, in which the solvent is evaporated through heat and mechanical action. The evaporated solvent is then re-condensed through a condensing coil equipped with a chiller and then passes back into vessel A, the solvent tank. Vessel C includes a first inlet for entry of the solvent rinsate into the evaporator and a second inlet for reagent, destruction solution, water, or other materials. For example, the second inlet into the rotary evaporator enables re-suspension of the pollutant into a concentrate

The processes and systems described herein provide efficient methods for activation of a sorbent, capture of a pollutant, desorption of the pollutant, concentration of the pollutant, and then destruction of the pollutant. For example, in some embodiments, the method of pollutant capture and destruction includes, prior to capturing an organic pollutant, cleaning and activating a porous polymer material by passing a first solvent such as a polar protic solvent through the porous polymer material to remove impurities and free up preexisting functional groups. Once the porous polymer is cleaned and active, the next step may be capturing at least one organic pollutant with the cleaned activated porous polymer. The at least one captured organic pollutant may then be released by passing a second solvent such as a second polar protic solvent through the porous polymer. The first solvent used for cleaning and activating the porous polymer may be the same or different from the second solvent used to release the captured organic pollutant from the porous polymer. The second solvent containing the released at least one captured organic pollutant may then be evaporated to concentrate the at least one organic pollutant. The concentrated at least one captured organic pollutant may then be destroyed, such as by using one of the methods described herein.

The systems provide complete, versatile and efficient ways to destroy various contaminants including organic environmental pollutants such as PFAS, organic dyes, and pesticides from sorbent media. As an end-of-life solution for environmental remediation of sorbent, the system avoids secondary contamination. In addition, the system can recover and reuse solvents to decrease or eliminate hazardous waste. The design can enable modular-based systems to easily fit around existing facilities or meet specific needs. While various solvents, additives, and other components have been described, the present disclosure is not limited those specifically identified. Other cleaning solutions are within the spirit and scope of the invention, including solutions with different compounds, combination of compounds and at different concentrations. For example, in some embodiments, combinations of polar organic solvents and bases can be used. Some solvents that can be used include, but are not limited to isopropyl alcohol, ethanol, acetone, and acetonitrile. Some bases that can be used include, but are not limited to potassium hydroxide, sodium hydroxide, and ammonium hydroxide. It should be recognized, however, that other solvents and/or bases may be used.

The examples show how de-sorption is important for sorbents as it enables two end of life options which may be included in various embodiments. The sorbent may be regenerated and reused. In addition, the contaminant such as PFAS may be concentrated for post treatment such as destruction and for disposal. This process enables end of life defluorination and degradation procedures that are otherwise limited in terms of size and scale, such as sonication, thermal treatment, and plasma treatment. Through efficient sorption and subsequent de-sorption, contaminants such as PFAS compounds can be captured and concentrated into small volume liquid waste streams. These small volume streams are much easier to treat via the methods mentioned.

The mechanical and chemical properties of materials like polyurethane and nylon make them ideal for both sorption and extraction processes. First, these materials are very mechanically robust and are able to withstand mixing and compression without losing their structural integrity. Chemically, these materials are stable in the presence of organic solvents and at high pH conditions, both of which are necessary for complete extraction.

The various embodiments described herein provide numerous competitive advantages. For example, smaller treatment systems may be used compared to large facilities needed for activated carbon, due to faster flow rates. There may be less material turnover because of the high loading capacity of the new sorbent technology. When activated carbon is used by other systems, it may be disposed of by incineration, which may cause secondary pollution by generating short-chain PFAS. In contrast, according to the various methods described herein, when sorbent such as polyurethane is used to recover PFAS and it is defluorinated, such as though acoustic cavitation, it does not produce hazardous byproducts.

### EXPERIMENTAL

In the following examples, an example porous polyurethane nanocomposite was analyzed before and after the addition of the target PFAS compound. In a typical setup, porous polyurethane nanocomposite is shredded to pieces with a size range between 0.25 and 3 cm in diameter with 1 cm being the ideal size. These pieces are tightly compressed into a column and water is flowed into this column in a manner that allows for a contact time of 1-20 minutes, with 10 minutes being the ideal contact time. For breakthrough testing, a concentration of 100 ppb PFOA was used.

### Example 1

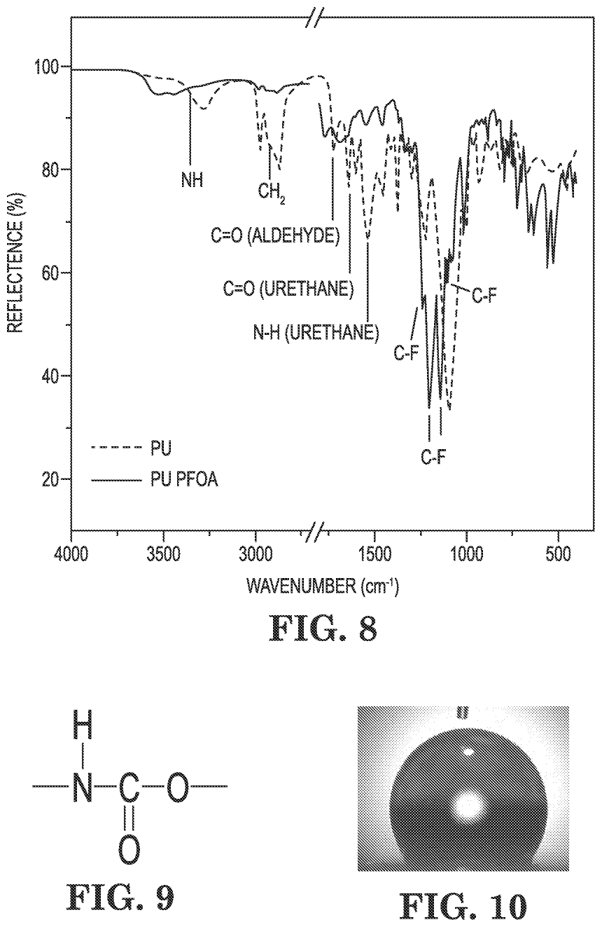

Fourier transformation infrared analysis was performed on a polyurethane support material before and after treatment with PFOA. The results are shown in FIG. 8. Characteristic peaks for the C—F bond are labelled indicating the presence of PFOA on the sorbent. FIG. 9 shows the general structure of the urethane bone.

FTIR analysis indicated electrostatic interactions between PFAS compounds and oxygen present in alcohol and urethane groups, carbon present in methyl functional groups, and in the urethane functional groups of the polyurethane support. FTIR analysis also confirmed sorption of PFAS compounds as characteristics peaks were observed for the C—F bond.

### Example 2

A contact angle measurement was performed using a polyurethane foam support material. The contact angle was 140±5 degrees. The hydrophobic surface is shown in the image in FIG. 10.

### Example 3

PFOA and PFOS were removed from a porous polyurethane nanocomposite as a function of target concentration. The resulting graphs were fit with a Langmuir isotherm model to predict the maximum theoretical “loading capacity” of the polyurethane materials, as reported in Table 2.

TABLE 2
Adsorption Parameters for the Activated Porous Polyurethane Nanocomposite

| | | | | Time to | Pseudo-second |
|---|---|---|---|---|---|
| | | Maximum Loading | Langmuir | Reach | order rate |
| | | Capacity - Langmuir | Constant | Equilibrium | constant |
| Material | Target | (mg target/g sorbent) | (mL/g, K_{L}) | (min) | (g/mg h, k₂) |
| Activated | PFOA | 6,498 | 1.41E−8 | 5 | 1.94 |
| Porous | | | | | |
| Polyurethane | PFOS | 2,285 | 1.14E−4 | 5 | 0.995 |
| Nanocomposite | | | | | |

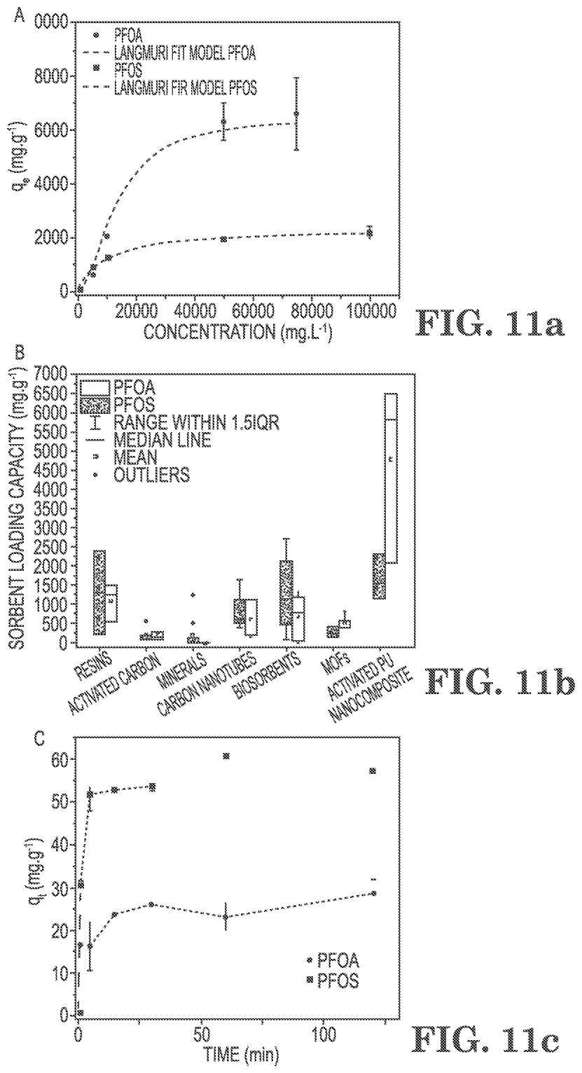

The results are shown in FIGS. 11a-11c. FIG. 11a shows the loading capacity for PFOA and PFOS with Langmuir isotherm fitting for an example activated porous polyurethane nanocomposite. FIG. 11b shows the calculated loading capacity of activated porous polyurethane nanocomposite compared to other available technologies includes ion exchange resins, activated carbon, and metal organic frameworks (MOFs) with the measurements from the other available technologies as reported by Zhang, D. Q., W. L. Zhang, and Y. N. Liang. “Adsorption of perfluoroalkyl and polyfluoroalkyl substances (PFASs) from aqueous solution-A review.” Science of The Total Environment 694 (2019): 133606. FIG. 11c shows the experimental sorption kinetic data for PFOA and PFOS.

A comparison of reported loading capacities for granular activated carbon as compared to the activated porous polyurethane nanocomposite is shown in Table 3.

TABLE 3
Adsorption Parameters for an Activated Porous
Polyurethane Nanocomposite vs Activated Carbon

| | Activated Porous | Granular Activated |
|---|---|---|
| | Polyurethane Nanocomposite | Carbon (GAC) |
| | Maximum Loading | Maximum Loading |
| | Capacity - Langmuir | Capacity - Langmuir |
| Target | (mg target/g sorbent) | (mg target/g sorbent) (6) |
| PFOA | 6498 | 165 |
| | | 12.6 |
| | | 22.7 |
| | | 102.7 |
| PFOS | 2285 | 110.0 |
| | | 2.59 |
| | | 2.53 |
| | | 2.44 |

### Example 4

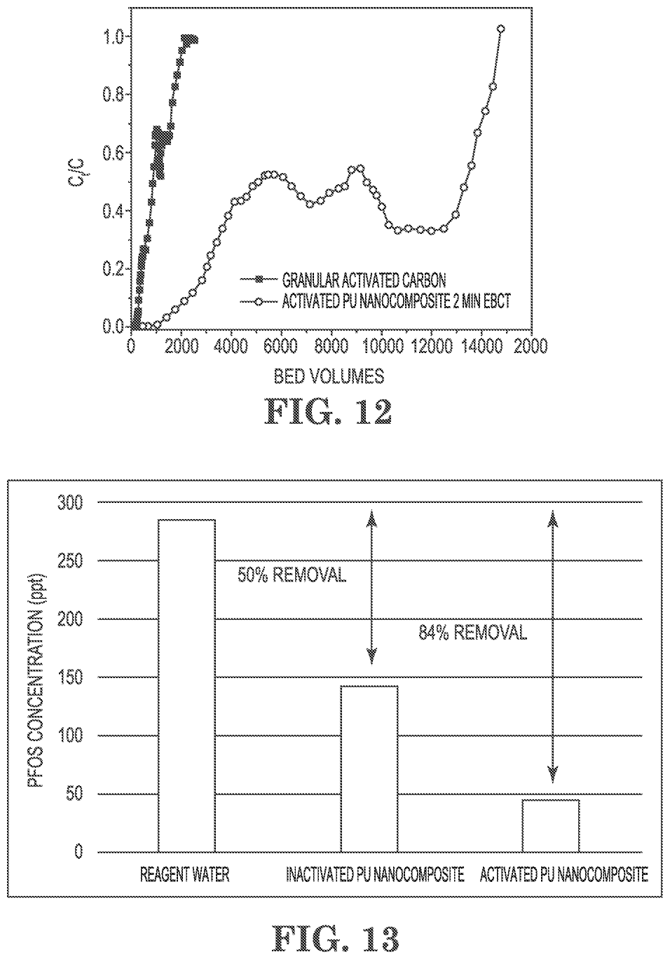

Breakthrough curves were created comparing granular activated carbon with a bed volume of 1008 ml to an activated porous polyurethane nanocomposite with a bed volume of 1950 ml. An influent concentration of 100 ppb and an EBCT of 10 minutes was used for the granular activated carbon while an EBCT of 2 minutes was used for the activated porous polyurethane nanocomposite. The results are shown in FIG. 12, in which the breakthrough curves show the concentration ratio of influent and effluent PFOA for activated porous polyurethane nanocomposite and granular activated carbon (GAC) as a function of time expressed in bed volumes. This figure illustrates the high performance of the activated porous polyurethane nanocomposite as compared to a commercially available granular activated carbon (GAC). With the granular activated carbon, 80% of a PFOA breaks through and is not captured at approximately 175 hours. In comparison, there is less than 10% breakthrough for 325 hours with the polyurethane.

### Example 5

The activated porous polyurethane nanocomposite was rinsed with 95% methanol and 5% ammonium to achieve the “activation” the polyurethane. This activated porous polyurethane nanocomposite was compared to “non-activated” porous polyurethane nanocomposite, which was the same material but without the activation treatment. The two materials were used to remove PFOS from an aqueous PFOS solution. The results are shown in FIG. 13. The “unactivated” porous polyurethane nanocomposite removed 49.9% of PFOS from the original reagent water at an original concentration of ˜285 ppt (FIG. 13). The activated porous polyurethane nanocomposite removed 84.3% of the PFOS from the original reagent water.

### Example 6

Small pieces of activated porous polyurethane nanocomposite ranging from 0.08 to 0.09 g were added to a shaker with 20 mL of ˜100 parts per billion (ppb) of PFOA and PFOS in water for a period of ten minutes. De-sorption was performed by collecting and soaking the foam in 20 mL of 96% methanol for 5 minutes. The results are shown in Table 4.

TABLE 4
Desorption of PFAS from activated
porous polyurethane nanocomposite

| | Average Amount | | |
|---|---|---|---|
| | Captured on | | |
| | Activated Porous | Average Desorption | |
| | Polyurethane | of Captured | |
| Sample | Nanocomposite (mg) | Amount (mg) | Desorption (%) |
| PFOA | 107.443 | 89.883 | 84.58 |
| PFOS | 130.64 | 127.98 | 97.97 |

The results show that over 80% of PFOA and 97% of PFOS can be recovered in this manner. This allows de-sorption sorbent regeneration and reuse and PFAS concentration for post treatment and disposal according to various embodiments.

### Example 6

In this example, PFAS degradation was performed through the use of a free radical generator, sodium persulfate. A concentrated volume of PFAS compounds in water was placed inside polypropylene bottle and submerged in an ultrasonicator reactor chamber (Meinhardt Ultrasonics). Sodium persulfate (1.25 g/L) was added to the solution of PFAS compounds. This mixture was then exposed to acoustic cavitation, by sonication at a frequency of 862 kHz for 60 minutes under a pulse mode whereby the sample was treated intermittently for 100 ms on and 100 ms off. The sample temperature was kept between 25 degrees Celsius and 40 degrees Celsius. Alternatively, a sweep mode can be used for sonication by alternating between high (600 kHz to 1000 kHz) and low frequency (200 kHz to 600 kHz) within a short period of time. For example, a frequency sweeping between 862 kHz and 358 kHz within 1000 ms can be used for the procedure. The results shown in Table 5.

TABLE 5
Defluorination of PFAS via Ultrasonication Process

| | Initial PFAS | Final PFAS | |
|---|---|---|---|
| | Concentration | Concentration | |
| | (parts per | (parts per | Destruction |
| Sample | billion, ppb) | billion, ppb) | (%) |
| PFOA | 5027.5 | 489.5 | 90.3% |
| PFOS | 5691.3 | 1109 | 80.51% |

### Example 7

Coating of PFAS Containers and Containment Vessels. In order to prevent PFAS losses to the walls of the defluorination treatment vessel an experiment was conducted to determine if a coating of long chain organic acids would be suitable for the aluminum reactor vessel. Applying a coating to the reactor can be of critical importance when handling highly concentrated PFAS wastes as losses to the walls of the reactor can dramatically reduce efficiency and result in flawed studies. Briefly, an aqueous solution of 0.2% (v/v) hexanoic acid was made and added to the vessel. The vessel was added to the sonicator and sonication was applied at a sweeping frequency from 200-300 kHz to 800-900 kHz for a period of 40 to 120 minutes. Upon completion of sonication, the organic acid solution was removed from the vessel and stable layer of hexanoic acid was observed on the surface of the vessel. A highly concentrated solution of PFOS was then added to the coated vessel. After an incubation period, the concentrated PFOS solution was collected and analyzed via LC/MS/MS. Table 6 shows the material losses to the walls of the reactor for a concentrated solution of PFOS. Through the simple addition of an organic acid, PFAS losses can be dramatically reduced.

TABLE 5
Defluorination of PFAS via Ultrasonication Process

| | Initial PFOS | Recovered PFOS | Percent |
|---|---|---|---|
| | Concentration | Concentration | Loss to |
| | (parts per | (parts per | Reactor |
| Sample | billion, ppb) | billion, ppb) | Walls (%) |
| PFOS in Uncoated | 13210.7 | 6558.2 | 50.4% |
| Vessel | | | |
| PFOS in Organic | 10348.8 | 10966.8 | 0% |
| Acid Coated Vessel | | | |

### Example 8

One method of destruction which may be used in various embodiments includes sonication induced cavitation which may be used for PFAS destruction. Water containing the dissolved PFAS was be subjected to ultrasonic waves at a frequency of 864 kHz. This was achieved by taking a known concentration of PFAS into a 50 mL aluminum bottle coated with hexanoic acid. This bottle was immersed into a water bath connected to an ultrasonic transducer and sonicated at 864 kHz for 3 hours. The results are shown in Table 6, which indicate that sonication induced cavitation for PFAS destruction. The use of sonication effectively destroyed PFOS and PFOA to a level of >90% through the cleavage of the carbon-fluorine bond.

TABLE 6
PFAS Defluorination

| | Initial PFAS | | |
|---|---|---|---|
| | Concentration | Final PFAS | |
| | (parts per | Concentration | |
| Sample | billion, ppb) | (ppb) | Destruction (%) |
| PFOA | 5027.5 | 489.5 | 90.3% |
| PFOS | 7097 | 748 | 89.5% |

### Example 9

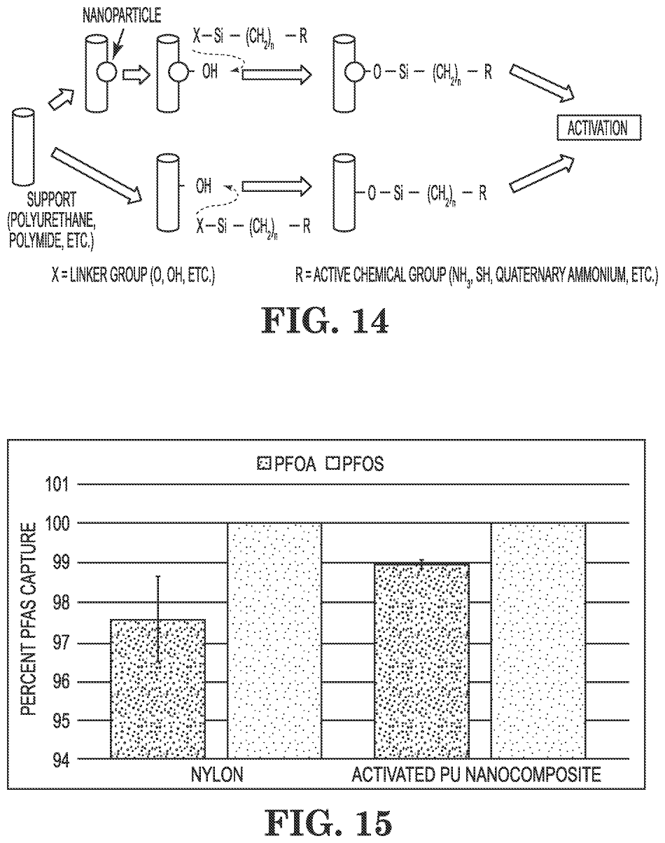

In this example, amine functional groups were introduced to a sorbent material in a process referred to herein as amination. In this case, a polyurethane foam was used. Amine containing polymers with a silane containing linker molecule at one end such as (3-aminopropyl) triethoxysilane (APTES) were introduced to the foam. In one case, the amine containing polymer were introduced to the foam through direct treatment of raw polyurethane. In another case, the amine treated polymers were introduced to the form through surface treatment of an iron nanomaterial directly bound to the polyurethane. Briefly, the polyurethane was added to a solution of an aminated silane in water for 30 minutes. Upon, removal the saturated polyurethane was removed and dried at room temperature for 12 hours. Through this process the silane linker is expected to bind to the nanoparticle surface and to carbonyl or alcohol groups in the polyurethane or other support (FIG. 14).

The sorbent materials including the iron nanomaterial and the amine polymers were placed into a syringe, whereupon an environmental wastewater was cyclically aspirated and plunged to evaluate the capture of shorter chain PFAS compounds, specifically perfluorobutanoic acid (PFBA) and perfluorobutanesulfonic acid (PFBS). The procedure was repeated using raw polyurethane, the aminated polyurethane without iron nanoparticles, and the aminated polyurethane with nanoparticles created as described above, This experiment demonstrated that the amination of this material improved its removal of PFBA and PFBS (Table 7).

TABLE 7
Short Chain PFAS Capture with Aminated Sorbents

| Material | PFBA Sorption (%) | PFBS Sorption (%) |
|---|---|---|
| Raw Polyurethane | 0.00 | 16.0 |
| Aminated Material | 89.20 | >99.9 |
| Iron Nanoparticle + | 86.07 | 29.14 |
| Amine Group | | |

### Example 10

Small pieces of nylon fiber sheets ranging from 0.08 to 0.1 g were added to a shaker with 20 mL of 10-15 parts per billion (ppb) of PFOA and PFOS in water for a period of 24 hours. For comparison, the same procedure was performed using small pieces of activated porous polyurethane nanocomposite in a shaker in place of the nylon fiber. The results are shown in the bar graph presented as FIG. 15, showing percept PFAS capture for each sorbent, including PFOA and PROS capture. As can be seen, the nylon exhibited similar sorption to activated porous polyurethane nanocomposite in removing over 97% of PFOA and PFOS as shown in FIG. 15.

### Example 11

One method of destruction which may be used in various embodiments includes the cleavage of carbon fluorine bonds through the use of a catalyst excited by ultraviolet light, referred to herein as UV photocatalysis. In this example, PFAS, specifically perfluorobutanoic acid (PFBA) at a concentration of 10-15 parts per million (ppm) was added to a 50 mL quartz test tube with a reducing agent (such as potassium iodide) in an oxygen free environment. Ultraviolet light was introduced to this sample at a wavelength of 254 nm for 2 hours. This test resulted in >99.0% destruction of PFBA as measured by liquid chromatography mass spectrometry.

### Example 12

In another example, destruction the cleavage of carbon fluorine bonds was achieved using UV photocatalysis. PFAS, specifically PFOS at a concentration of 10-15 parts per million (ppm) was added to a 50 mL quartz test tube with a reducing agent in an oxygen free environment. Ultraviolet light was introduced to this sample at a wavelength of 254 nm for 2 hours. The results are shown in Table 8 below. Destruction was measured by determining initial vs final concentration of PFOS by liquid chromatography mass spectrometry (LC-MS). To measure defluorination, cleavage of the carbon fluorine bond, the sample was submitted to total organofluorine analysis to measure total PFAS before and after treatment. Using these two methods in tandem, it was determined that the total defluorination efficiency of the process was nearly ˜80%.

TABLE 8
PFAS Defluorination with UV Photocatalysis

| | Initial | Final | Total | | |
|---|---|---|---|---|---|
| | Concentration | Concentration | Organofluorine | Destruction | Defluorination |
| Sample | (LC-MS) (ppm) | (LC-MS) (ppm) | (TOF) (ppm) | (%) | (%) |
| PFOS | 13.7 | 2.1 | 1.9 | 84.6% | 79.1% |

As used herein, the terms “substantially” or “generally” refer to the complete or near complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is no significant effect thereof.

In the foregoing description various embodiments of the invention have been presented for the purpose of illustration and description. They are not intended to be exhaustive or to limit the invention to the precise form disclosed. Obvious modifications or variations are possible in light of the above teachings. The embodiments were chosen and described to provide illustrations of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

What is claimed is:

1. A sorbent system comprising:
a porous polymer material; and
at least one active chemical group bound to an outer surface of the porous polymer material and within the porous polymer material.

2. The sorbent system of claim 1 wherein the porous polymer material comprises a foam.

3. The sorbent system of claim 2 wherein the foam comprises polyurethane.

4. The sorbent system of claim 1 wherein the porous polymer material comprises a fibrous polymer sheet.

5. The sorbent system of claim 4 wherein the fibrous polymer sheet comprises a polyamide.

6. The sorbent system of claim 1 wherein the at least one active chemical group comprises at least one of amines, thiols, and alcohols.

7. The sorbent system of claim 1 wherein the active chemical groups are hydrophobic.

8. A sorbent system comprising:
a porous polymer material;
nanoparticles bound to an outer surface of the porous polymer material and within the porous polymer material; and
at least one active chemical group bound to the nanoparticles.

9. The sorbent system of claim 8 wherein the nanoparticles comprise one or more metals or metal oxides.

10. The sorbent system of claim 8 wherein each of the plurality of nanoparticles has a diameter between 1 nm to 500 nm.

11. The sorbent system of claim 8 wherein the nanoparticles comprise one or more of titanium, iron, manganese, zinc, silicon or oxides or hydroxides thereof.

12. The sorbent system of claim 8 wherein the at least one active chemical group comprises one or more amine, thiol, or alcohol.

13. The sorbent system of claim 8 wherein the active chemical groups are hydrophobic.

14. The sorbent system of claim 8 wherein the porous polymer material comprises a foam.

15. The sorbent system of claim 14 wherein the foam comprises polyurethane.

16. The sorbent system of claim 8 wherein the polymer porous polymer material comprises a polyamide.

17. A method of desorbing bound persistent organic compounds from a sorbent comprising:
adding a sorbent to a vessel, the sorbent comprising a porous polymer with one or more persistent organic compounds bound to the sorbent;
adding a solvent solution to the vessel, the solvent solution comprising an organic solvent and an organic base; and
passing the solvent solution through the sorbent in the vessel to release the bound persistent organic compounds from the sorbent into the solvent solution.

18. The method of claim 17 wherein the persistent organic compound comprises a perfluoroalkyl substance or a polyfluoroalkyl substance.

19. The method of claim 18 wherein the organic solvent comprises an organic acid or an organic alcohol.

20. The method of claim 19 wherein the organic solvent comprises methanol, ethanol, and isopropanol.

21. The method of claim 17 wherein the sorbent comprises a foam.

22. The method of claim 21 wherein the foam comprises polyurethane.

23. The method of claim 21 wherein passing the solvent through the sorbent in the vessel comprises mechanically compressing and releasing the polyurethane foam in the solvent solution.

24. The method of claim 17 wherein the vessel comprises an interior surface coated with long chain organic molecules.

25. The method of claim 24 wherein the long chain organic molecule comprises a long aliphatic or branched chain organic acid or alcohol.

26. A method of destroying captured persistent organic compounds, the method comprising:
passing a solvent solution through a sorbent having a bound persistent organic compound to release the persistent organic compound into the solvent solution;
concentrating the released persistent organic compound; and
applying energy to the released persistent organic compound to destroy the persistent organic compound.

27. The method of claim 26 wherein the energy comprises acoustic cavitation.

28. The method of claim 27 wherein the acoustic cavitation energy has a frequency of about 200 kHz to about 1000 kHz.

29. The method of claim 27 wherein the acoustic cavitation energy has a frequency of about 850 kHz.

30. The method of claim 26 wherein the persistent organic compound comprises a perfluoroalkyl substance or a polyfluoroalkyl substance.

31. The method of claim 30 wherein destroying the persistent organic compound comprises defluorinating the persistent organic compound.

32. The method of claim 31 wherein the energy comprises locally applied energy.

33. The method of claim 32 wherein the locally applied energy comprises ultrasound energy, UV energy, electrical energy, or energy under supercritical conditions.

34. The method of claim 26 wherein concentrating the released persistent organic compounds comprising evaporating the solvent solution.

35. The method of claim 34 wherein evaporating the solvent solution comprises at least one of heating the solvent solution and evaporating the solvent solution under vacuum.

36. The method of claim 34 further comprising suspending the concentrated persistent organic compounds in water prior to applying destructive energy.

37. A method of capturing persistent organic compounds present in a liquid, the method comprising:
passing a contaminated liquid containing a persistent organic compound through a sorbent, the sorbent comprising a porous polymer with bound active chemical groups on a surface of the porous polymer and within the porous polymer.

38. The method of claim 37 wherein the porous polymer comprises a polyurethane foam.

39. The method of claim 37 further comprising, prior to passing the contaminated liquid through the sorbent, exposing the polyurethane foam to a solvent to increase binding capacity of the sorbent.

40. The method of claim 39 wherein the solvent comprises methanol and ammonium hydroxide.

41. A method of activating a porous polymer material, comprising;
prior to capturing an organic pollutant, cleaning and activating a porous polymer material by passing a first polar protic solvent through the porous polymer material to remove impurities and free up preexisting functional groups;
capturing at least one organic pollutant with the cleaned activated porous polymer;
passing a second polar protic solvent through the porous polymer to release the at least one captured organic pollutant from the porous polymer into the second polar protic solvent;
evaporating the polar protic solvent containing the released at least one captured organic pollutant to concentrate the at least one organic pollutant; and
destroying the concentrated at least one captured organic pollutant;
wherein the first and second polar protic solvents may be the same solvent or may be different solvents.

42. The method of claim 41 wherein the porous polymer material comprises a foam.

43. The method of claim 42 wherein the porous polymer material comprises polyurethane.

44. The method of claim 43 wherein destroying the concentrated at least one captured organic pollutant comprises applying acoustic cavitation energy to the at least one captured organic pollutant.

45. An apparatus for the destruction of captured pollutants comprising:
a vessel comprising:
a vessel wall, the vessel wall comprising an interior surface enclosing an interior space, wherein the interior surface is coated with a long chain organic molecule;
a first inlet in fluid communication with a reagent supply,
a second inlet in fluid communication with a source of desorbed pollutant in a solvent, and
an outlet;
an energy source configured to direct energy into the interior space, the energy comprising one or more of ultrasound energy at a frequency of about 200 kHz to about 1000 kHz, UV energy at about 100 nm to about 400 nm, and/or visible light at about 400 to about 700 nm.

46. A system for destroying captured pollutants comprising:
a first vessel comprising a desorption vessel, the desorption vessel comprising:
a vessel wall defining an interior space, one or more inlets configured to receive a sorbent containing captured pollutant and a solvent, and an outlet; and
one or more mechanical elements to cause flow of the solvent through the sorbent to facility desorption of the pollutant from the sorbent into the solvent;
a second vessel comprising a concentration vessel comprising:
a vessel wall defining an interior space, an inlet and an outlet; and
apparatus for concentrating or evaporating the solvent in the interior space; and
a third vessel comprising a destruction vessel, the destruction vessel comprising:
a vessel wall defining an interior space, an inlet and an outlet; and
an energy source configured to direct destructive energy into the interior space;
wherein the first, second and third vessels are in fluid communication such that, after the captured pollutant is released from the sorbent in the desorption vessel, it flows from the outlet of the first vessel to the inlet of the second vessel and into the second vessel, and then from the outlet of the second vessel to the inlet of the third vessel and into the third vessel.

47. A sorbent system comprising:
a porous polymer material; and
a plurality of nanoparticles bound to an outer surface of the porous polymer material and within the porous polymer material.

48. The sorbent system of claim 47 wherein the plurality of nanoparticles has a diameter between 1 nm to 500 nm.

49. The sorbent system of claim 47 wherein the nanoparticles comprise titanium, iron, manganese, zinc, silicon or oxides and hydroxides thereof.

50. The sorbent system of claim 47 further comprising at least one active chemical group bound to the nanoparticles.

52. The sorbent system of claim 50 wherein the plurality of nanoparticles has a diameter between 1 nm to 500 nm.

53. The sorbent system of claim 50 wherein the nanoparticles comprise titanium, iron, manganese, zinc, silicon or oxides and hydroxides thereof.

54. The sorbent system of claim 50 wherein the at least one active chemical group comprises at least one of amines, thiols, and alcohols.

55. The sorbent system of claim 50 wherein the active chemical groups are hydrophobic.
